(19) United States
(12) Patent Application Publication
(10) Pub. No.: US 2021/0286946 A1
(43) Pub. Date: Sep. 16, 2021

(54) APPARATUS AND METHOD FOR LEARNING TEXT DETECTION MODEL

(71) Applicant: SAMSUNG SDS CO., LTD., Seoul (KR)

(72) Inventors: Kyu Sam OH, Seoul (KR); Eun Soo JUNG, Seoul (KR); Hyeong Gwan SON, Seoul (KR); Soon Hwan KWON, Seoul (KR); Yong Keun YUN, Seoul (KR)

(21) Appl. No.: 17/082,396

(22) Filed: Oct. 28, 2020

(30) Foreign Application Priority Data
Mar. 16, 2020 (KR) 10-2020-0032093
Jul. 30, 2020 (KR) 10-2020-0095001

(51) Int. Cl. G06F 40/279; G06K 9/00; G06K 9/62; G06N 20/00

(52) U.S. Cl. CPC G06F 40/279; G06K 9/00442; G06K 2209/01; G06N 20/00; G06K 9/6202

(57) ABSTRACT

An apparatus according to an embodiment includes a first training module configured to perform a first training on a text detection model which receives a document image and outputs a text score map and a text mask for the document image by using first training data including text detection ground truth (GT) and text enhancement GT, and a second training module configured to perform a second training on the text detection model by using second training data including only the text detection GT.

### CROSS-REFERENCE TO RELATED APPLICATION(S)

This application claims the benefit under 35 USC § 119(a) of Korean Patent Application Nos. 10-2020-0032093 filed on Mar. 16, 2020 and 10-2020-0095001 filed on Jul. 30, 2020, in the Korean Intellectual Property Office, the entire disclosure of which is incorporated herein by reference for all purposes.

### BACKGROUND

### 1. Field

The disclosed embodiments relate to a machine learning-based text detection technology.

### 2. Description of Related Art

Optical character recognition (OCR) is a technology of acquiring an image of characters written by a person or printed by a machine with an image scanner and converting it into machine-readable characters. Initially, a pattern matching method was mainly used for character recognition, but recently, a machine learning-based character recognition technology has been developed.

The character recognition technology in the related art has been mainly developed with a focus on increasing the recognition rate of characters themselves. Therefore, when the quality of the document itself is low, for example, when there are spots, watermarks, wrinkles, or the like in the document, it is likely that the recognition rate of characters is lowered. In addition, since the technology for improving the document quality has been developed independently from the character recognition technology, when the quality of the document is low, a two-step process, that is, a step of increasing the quality of the document and then a step of recognizing characters are needed to be performed, which may be cumbersome.

### SUMMARY

Embodiments disclosed herein are to provide a technical means for improving document quality as well as performing text detection by using machine learning.

According to an embodiment, there is disclosed an apparatus for training a text detection model, the apparatus including a first training module configured to perform a first training on the text detection model which receives a document image and outputs a text score map and a text mask for the document image by using first training data including text detection ground truth (GT) and text enhancement GT; and a second training module configured to perform a second training on the text detection model by using second training data including only the text detection GT.

The first training module may be further configured to input the first training data into the text detection model, acquire a first text score map and a first text mask for the first training data from the text detection model, and calculate a loss of the first training by comparing the acquired first text score map and first text mask with the text detection GT and the text enhancement GT of the first training data.

The first training module is further configured to calculate the loss of the first training using the following equation:

L₁=λL_{D}+(1−λ)L_{E}

(here, L₁ is a loss function of the first training, L_{D} is a text detection loss between the first text score map and the text detection GT of the first training data, L_{E} is a text enhancement loss between the first text mask and the text enhancement GT of the first training data, and λ is a weight).

The second training module may be further configured to input the second training data into the text detection model, acquire a second text score map and a second text mask for the second training data from the text detection model, calculate a first text detection loss by comparing the acquired second text score map with the text detection GT of the second training data, and calculate one or more of a text enhancement loss of the second training data and a second text detection loss by comparing the second text mask with the text detection GT of the second training data.

The second training module may be further configured to calculate the text enhancement loss of the second training data by using a false positive loss when comparing the second text mask with a blank region of the text detection GT of the second training data.

The second training module may be further configured to input the second text mask into the text detection model, acquire a third text score map for the second text mask from the text detection model, and calculate the second text detection loss by comparing the acquired third text score map with the text detection GT of the second training data.

The second training module may be further configured to calculate the loss of the second training by using the first text detection loss, the text enhancement loss, and the second text detection loss.

The second training module is further configured to calculate the loss of the second training using the following equation:

L₂=λ₁L_{D}+(1−λ₁)(λ₂L_{D′}+(1−λ₂)L_{FP})

(here, L₂ is a loss function of the second training, L_{D} is the first text detection loss, L_{D′} is the second text detection loss, L_{FP} is the text enhancement loss of the second training data, and λ₁ and λ₂ are weights).

According to another embodiment, there is disclosed a method for training a text detection model, which is performed in a computing device including one or more processors and a memory storing one or more programs executed by the one or more processors, the method comprising: a first training step of training a text detection model which receives a document image and outputs a text score map and a text mask for the document image by using first training data including text detection ground truth (GT) and text enhancement GT; and a second training step of training the text detection model by using second training data including only the text detection GT.

The first training step may include inputting the first training data into the text detection model, acquiring a first text score map and a first text mask for the first training data from the text detection model, and calculating a loss of the first training step by comparing the acquired first text score map and first text mask with the text detection GT and the text enhancement GT of the first training data.

The calculating of the loss of the first training step may include calculating the loss of the first training step using the following equation:

L₁=λL_{D}+(1−λ)L_{E}

(here, L₁ is a loss function of the first training step, L_{D} is a text detection loss between the first text score map and the text detection GT of the first training data, L_{E} is a text enhancement loss between the first text mask and the text enhancement GT of the first training data, and λ is a weight).

The second training step may include inputting the second training data into the text detection model; acquiring a second text score map and a second text mask for the second training data from the text detection model, calculating a first text detection loss by comparing the acquired second text score map with the text detection GT of the second training data, and calculating one or more of a text enhancement loss of the second training data and a second text detection loss by comparing the second text mask with the text detection GT of the second training data.

The calculating of the one or more of the text enhancement loss of the second training data and the second text detection loss may include calculating the text enhancement loss of the second training data by using a false positive loss when comparing the second text mask with a blank region of the text detection GT of the second training data.

The calculating of the one or more of the text enhancement loss of the second training data and the second text detection loss may include inputting the second text mask into the text detection model, acquiring a third text score map for the second text mask from the text detection model, and calculating the second text detection loss by comparing the acquired third text score map with the text detection GT of the second training data.

The second training step may further include calculating the loss of the second training step by using the first text detection loss, the text enhancement loss, and the second text detection loss.

The calculating of the loss of the second training step may include calculating the loss of the second training step using the following equation:

L₂=λ₁L_{D}+(1−λ₁)(λ₂L_{D′}+(1−λ₂)L_{FP})

(here, L₂ is a loss function of the second training step, L_{D} is the first text detection loss, L_{D′} is the second text detection loss, L_{FP} is the text enhancement loss of the second training data, and λ₁ and λ₂ are weights).

### BRIEF DESCRIPTION OF THE DRAWINGS

FIG. 1 is a block diagram illustrating an apparatus 100 for training a text detection model according to an embodiment.

FIG. 2 is an exemplary diagram illustrating first training data according to an embodiment.

FIG. 3 is an exemplary diagram illustrating a process of performing training (first training) on a text detection model M in a first training module 102 according to an embodiment.

FIG. 4 is an exemplary diagram illustrating a process of performing training (second training) on a text detection model M in a second training module 104 according to an embodiment.

FIG. 5 is a flowchart illustrating a method 500 for training a text detection model according to an embodiment.

FIG. 6 is a block diagram exemplarily illustrating a computing environment that includes a computing device suitable for use in embodiments.

### DETAILED DESCRIPTION

Hereinafter, specific embodiments of the present invention will be described with reference to the accompanying drawings. The following detailed description is provided to assist in a comprehensive understanding of the methods, devices and/or systems described herein. However, the detailed description is only for illustrative purposes and the present invention is not limited thereto.

In describing the embodiments of the present invention, when it is determined that detailed descriptions of known technology related to the present invention may unnecessarily obscure the gist of the present invention, the detailed descriptions thereof will be omitted. The terms used below are defined in consideration of functions in the present invention, but may be changed depending on the customary practice or the intention of a user or operator. Thus, the definitions should be determined based on the overall content of the present specification. The terms used herein are only for describing the embodiments of the present invention, and should not be construed as limitative. Unless expressly used otherwise, a singular form includes a plural form. In the present description, the terms “including”, “comprising”, “having”, and the like are used to indicate certain characteristics, numbers, steps, operations, elements, and a portion or combination thereof, but should not be interpreted to preclude one or more other characteristics, numbers, steps, operations, elements, and a portion or combination thereof.

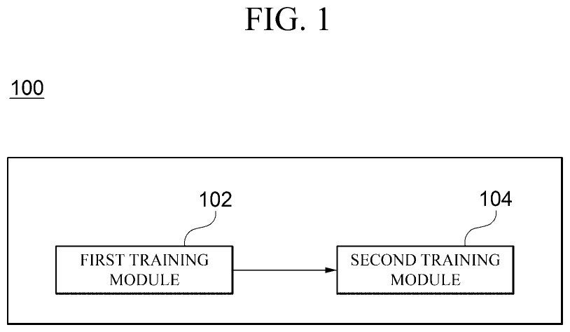

FIG. 1 is a block diagram illustrating an apparatus 100 for training a text detection model according to an embodiment.

In an embodiment, the apparatus 100 for training the text detection model is an apparatus for training a text detection model, which is a machine learning model (or an artificial neural network model) for recognizing a character from a document. In the disclosed embodiments, a text detection model M is a kind of multi-task model, and simultaneously performs, on an input document, two tasks, that is, a text region detection task and a text enhancement task. To this end, the text detection model has two outputs. Of the two, a text score map is output from the first output and a text mask is output from the second output. The text score map represents a region where characters exist on the input document, and the text mask removes background noise from the input document and represents only text. In the disclosed embodiments, a model network for machine learning may use various types of networks such as U-Net and Feature Pyramid Network (FPN), but is not limited to a specific type of network.

Meanwhile, in the disclosed embodiments, it should be noted that “text enhancement” is understood as a concept including not only dividing a document image into pixels corresponding to text and the rest (background, picture, line, noise, watermark, or the like) based on a preset threshold, but also clearly reconstructing blurred or partially erased portions in the document.

As illustrated in FIG. 1, the apparatus 100 for training the text detection model according to an embodiment includes a first training module 102 and a second training module 104.

The first training module 102 performs training on the text detection model M by using first training data. In this case, the first training data means training data including both text detection ground truth (GT) and text enhancement GT. In an embodiment, the first training data may be data that has been previously composed for training the text detection model M, rather than actual data.

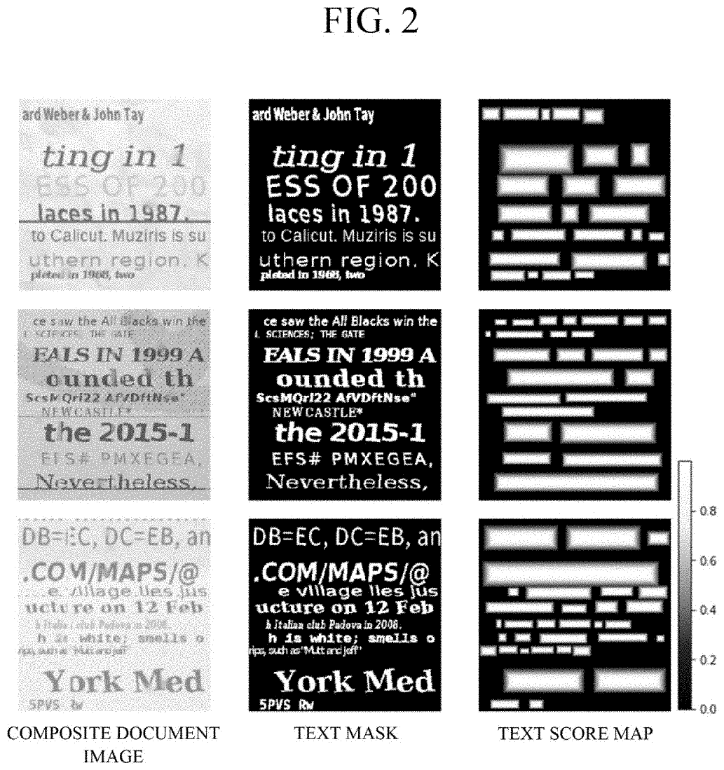

FIG. 2 is an exemplary diagram illustrating first training data according to an embodiment.

In order to train a text detection model for text detection, a large amount of documents labeled with character/word information and their location information included in the documents are required. However, the amount of document data that is currently published is very insufficient for training deep neural networks. In addition, although the number of characters in document data is much larger than that of signboards or signs, there is relatively little change in font, size, and shape. Therefore, document photos or scanned images may be generated more efficiently than other types of images. Accordingly, the disclosed embodiment is configured such that training is performed with first training data including document data composed in the first training step, and then training is performed with second training data including both actual data and composite data in the second training step.

In the example illustrated in FIG. 2, the leftmost column represents composite document images, the middle column represents text masks generated from each of the composite document images, and the right column represents text score maps.

In an embodiment, the composite document image may be generated by collecting a large amount of sentences to create a corpus and then arranging them on various paper image backgrounds. In this case, the background image may be implemented by using a paper image including various changes that may occur in an actual document, such as a paper image photographed under various lighting, a photographed or scanned image of paper with stains, watermarks, wrinkles, or the like. In addition, the text disposed on the background image may be randomly selected and disposed in the corpus. In this case, each text may be expressed using different font size, font, or color. In addition, each text may include noise such as underlines, lines due to the border of the table, stains, and smudges, and may express a case where the text is blurred due to poor printing or the resolution is degraded during the scanning process. In other words, the first composite data is document image data that is artificially composed by assuming various situations that may appear in a document generally made of paper.

The text masks are obtained by removing the background, noise color, or the like from the composite document image, and displaying only text on the background without any pattern. In the exemplary diagram of FIG. 2, examples in which white characters are arranged on a black background are illustrated. The text masks are used as the text enhancement GT in the later training process.

The text score maps represent the regions in which characters exist in the composite document image in the form of a box. In this case, in each box, weights may be given depending on positions in the box by using a Gaussian distribution or the like such that a higher score may be given toward the center. In the embodiment of FIG. 2, gradations are used to visually display the weights. That is, the brighter in each text box, the higher the score.

Since the first training data knows character/word information and location information which constitutes the text in the process of generating a document image, a large amount of documents for training may be easily generated. Accordingly, it is possible to solve the problem of insufficient training data required in machine learning.

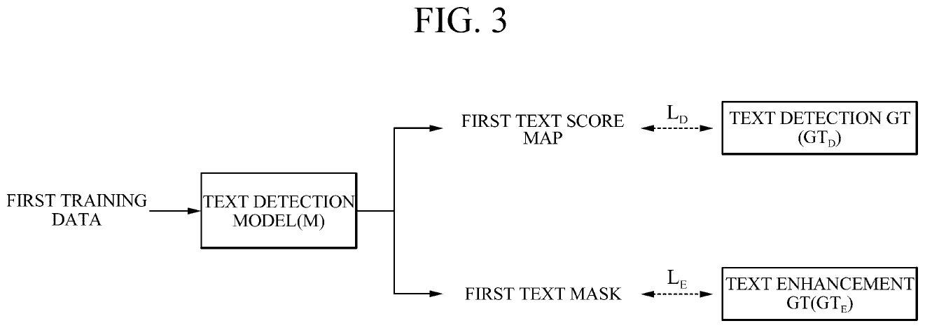

FIG. 3 is an exemplary diagram illustrating a process of performing training (first training) on a text detection model M in a first training module 102 according to an embodiment.

The first training module 102 may perform training on the text detection model M by using a fully-supervised training method.

Specifically, the first training module 102 may input the first training data into the text detection model M, acquire a first text score map and a first text mask therefrom, and then calculate a loss of the first training step by comparing the acquired first text score map and first text mask with text detection ground truth (GT_{D}) and text enhancement ground truth (GT_{E}). In this case, the loss of the first training step may be calculated by Equation 1 below.

L₁=λL_{D}+(1−λ)L_{E} [Equation 1]

Here, L₁ is a loss function of the first training step, L_{D} is a text detection loss between the first text score map and the text detection GT (GT_{D}) of the first training data, L_{E} is a text enhancement loss between the first text mask and the text enhancement GT (GT_{E}) of the first training data, and λ is a weight. The weight is for adjusting the reflection ratio between the text detection loss (L_{D}) and the text enhancement loss (L_{E}) in the loss function, and may have a value in a range of 0 to 1.

Referring back to FIG. 1, the second training module 104 performs second training on the text detection model M in which the first training has ended by using the second training data. In this case, the second training data may include both composite data and actual data. The difference between the actual data and the composite data is that the composite data includes both the text detection GT and the text enhancement GT, whereas the actual data includes only the text detection GT. That is, in the case of actual data, the type and position of the text may be known, but a text mask (text enhancement GT) from which noise existing in the document itself is removed is not provided. Therefore, the second training module 104 trains the text enhancement task by using weakly supervised training.

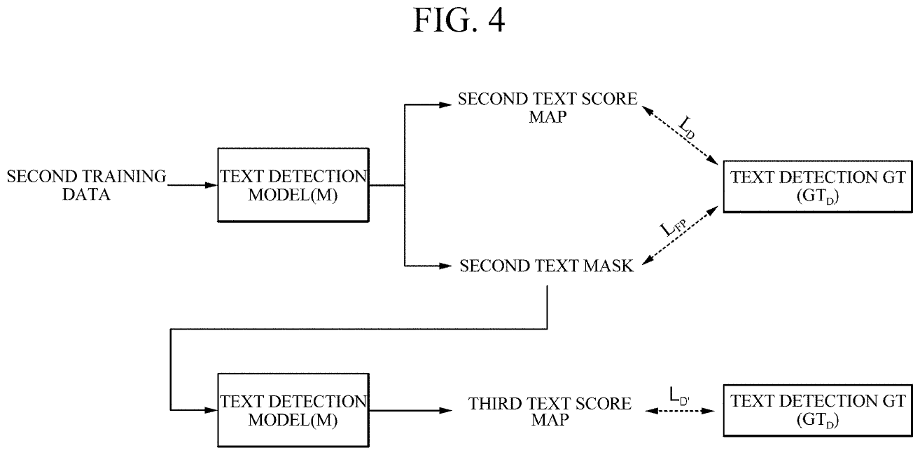

FIG. 4 is an exemplary diagram illustrating a process of performing training (second training) on a text detection model M in a second training module 104 according to an embodiment.

In the second training step, the second training module 104 inputs the second training data into the text detection model M and acquires a second text score map and a second text mask therefrom. Then, the second training module 104 calculates a first text detection loss by comparing the acquired second text score map with the text detection GT (GT_{D}) of the second training data.

On the other hand, as described above, the second training data includes actual data, and the actual data does not have text enhancement GT (GT_{E}). Therefore, it is not possible to calculate the text enhancement loss in the same manner as in the first training step. To solve this problem, the second training module 104 calculates the text enhancement loss of the second training data by using the text detection GT (GT_{D}) instead of the text enhancement GT (GT_{E}). Specifically, the second training module 104 calculates the text enhancement loss (L_{FP}) of the second training data by comparing the second text mask with a blank region of the text detection GT (GT_{D}) of the second training data. In this case, the text enhancement loss (L_{FP}) of the second training data may be a false positive loss when comparing the second text mask with the blank region. The text detection GT (GT_{D}) represents the region in the document where characters exist in the form of a box. Therefore, it is not possible to know the exact shape of the text like the text enhancement GT (GT_{E}), but through the text detection GT (GT_{D}), it is possible to derive a region where the text does not exist in the document. By using this, the second training module 104 may check whether or not the text is recognized in a region where the text does not exist in the second text mask (false positive), and may calculate the text enhancement loss (L_{FP}) of the second training data therefrom.

On the other hand, the second text mask may also be considered as a document with characters. Accordingly, the second training module 104 may input the second text mask into a text detection model M′, and may acquire a third text score map therefrom. Here, the text detection model represented by M′ is the same model as the text detection model represented by M, but is different in that it outputs only the text score map, not the text mask.

Then, the second training module 104 may calculate the second text detection loss (L_{D′}) by comparing the acquired third text score map with the text detection GT (GT_{D}) of the second training data, and may calculate the loss of the second training step by using the first text detection loss (L_{D}), the text enhancement loss (L_{FP}), and the second text detection loss (L_{D′}).

In this case, the loss of the second training step may be calculated by Equation 2 below.

L₂=λ₁L_{D}+(1−λ₁)(λ₂L_{D′}+(1−λ₂)L_{FP})

Here, L₂ is a loss function of the second training step, L_{D} is the first text detection loss, L_{D′} is the second text detection loss, L_{FP} is the text enhancement loss of the second training data, and λ₁ and λ₂ are weights having values in a range of 0 to 1.

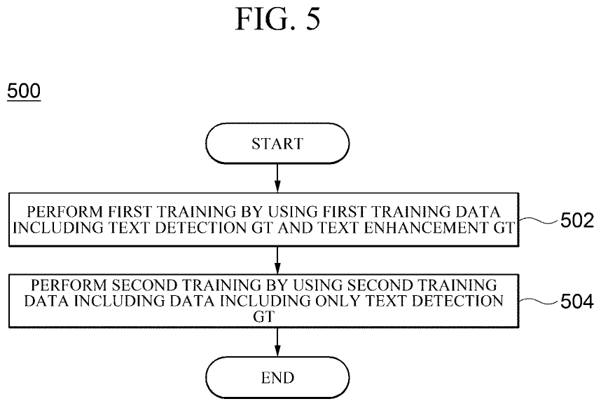

FIG. 5 is a flowchart illustrating a method 500 for training a text detection model according to an embodiment.

The illustrated flowchart may be performed by a computing device including one or more processors, and a memory storing one or more programs executed by the one or more processors, for example, the aforementioned apparatus 100 for training the text detection model. In the illustrated flowchart, the method or process is divided into a plurality of steps; however, at least some of the steps may be performed in a different order, performed together in combination with other steps, omitted, performed in subdivided steps, or performed by adding one or more steps not illustrated.

In step 502, the first training module 502 trains a text detection model by using the first training data including the text detection GT and the text enhancement GT. In this case, the text detection model refers to a model for receiving a document image and outputting a text score map and a text mask for the document image therefrom. As described above, in the present step, the first training module 102 may perform training on the text detection model M by using a fully-supervised training method.

In step 504, the second training module 504 trains the text detection model by using the second training data including data provided with only the text detection GT without the text enhancement GT. In the present step, the second training data includes actual data, and the actual data does not have text enhancement GT (GTE). Therefore, the second training module 104 trains the text enhancement task by using a weakly supervised training method, rather than the fully supervised training method.

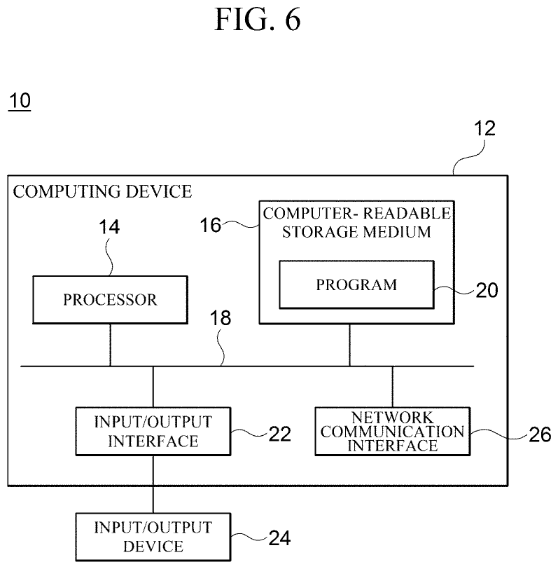

FIG. 6 is a block diagram exemplarily illustrating a computing environment 10 that includes a computing device suitable for use in embodiments. In the illustrated embodiments, each component may have different functions and capabilities in addition to those described below, and additional components may be included in addition to those described below.

The illustrated computing environment 10 includes a computing device 12. In an embodiment, the computing device 12 may be the apparatus 100 for training the text detection model according to an embodiment. The computing device 12 includes at least one processor 14, a computer-readable storage medium 16, and a communication bus 18. The processor 14 may cause the computing device 12 to operate according to the above-described exemplary embodiments. For example, the processor 14 may execute one or more programs stored in the computer-readable storage medium 16. The one or more programs may include one or more computer-executable instructions, which may be configured to cause, when executed by the processor 14, the computing device 12 to perform operations according to the exemplary embodiments.

The computer-readable storage medium 16 is configured to store computer-executable instructions or program codes, program data, and/or other suitable forms of information. A program 20 stored in the computer-readable storage medium 16 includes a set of instructions executable by the processor 14. In an embodiment, the computer-readable storage medium 16 may be a memory (a volatile memory such as a random access memory, a non-volatile memory, or any suitable combination thereof), one or more magnetic disk storage devices, optical disk storage devices, flash memory devices, other types of storage media that are accessible by the computing device 12 and may store desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 via the input/output interface 22. The exemplary input/output device 24 may include a pointing device (a mouse, a trackpad, or the like), a keyboard, a touch input device (a touch pad, a touch screen, or the like), a voice or sound input device, input devices such as various types of sensor devices and/or imaging devices, and/or output devices such as a display device, a printer, a speaker, and/or a network card. The exemplary input/output device 24 may be included inside the computing device 12 as a component constituting the computing device 12, or may be connected to the computing device 12 as a separate device distinct from the computing device 12.

According to embodiments disclosed herein, it is possible to efficiently and accurately detect characters existing in a document and acquire a high quality document with improved quality of the document itself by improving document quality and performing text detection at the same time.

Meanwhile, the embodiments of the present invention may include a program for performing the methods described herein on a computer, and a computer-readable recording medium including the program. The computer-readable recording medium may include program instructions, a local data file, a local data structure, or the like alone or in combination. The media may be specially designed and configured for the present invention, or may be commonly used in the field of computer software. Examples of computer-readable recording media include magnetic media such as hard disks, floppy disks and magnetic tapes, optical recording media such as a CD-ROM and a DVD, and hardware devices specially configured to store and execute program instructions such as a ROM, a RAM, and a flash memory. Examples of the program may include not only machine language codes such as those produced by a compiler, but also high-level language codes that can be executed by a computer using an interpreter or the like.

Although the representative embodiments of the present invention have been described in detail as above, those skilled in the art will understand that various modifications may be made thereto without departing from the scope of the present invention. Therefore, the scope of rights of the present invention should not be limited to the described embodiments, but should be defined not only by the claims set forth below but also by equivalents of the claims.

What is claimed is:

1. An apparatus for training a text detection model, the apparatus comprising:
a first training module configured to perform a first training on the text detection model which receives a document image and outputs a text score map and a text mask for the document image by using first training data including text detection ground truth (GT) and text enhancement GT; and
a second training module configured to perform a second training on the text detection model by using second training data including only the text detection GT.

2. The apparatus for training the text detection model of claim 1, wherein the first training module is further configured to:
input the first training data into the text detection model;
acquire a first text score map and a first text mask for the first training data from the text detection model; and
calculate a loss of the first training by comparing the acquired first text score map and first text mask with the text detection GT and the text enhancement GT of the first training data.

3. The apparatus for training the text detection model of claim 2, wherein the first training module is further configured to calculate the loss of the first training using the following equation:
L₁=λL_{D}+(1−λ)L_{E}
where L₁ is a loss function of the first training, L_{D} is a text detection loss between the first text score map and the text detection GT of the first training data, L_{E} is a text enhancement loss between the first text mask and the text enhancement GT of the first training data, and λ is a weight.

4. The apparatus for training the text detection model of claim 1, wherein the second training module is further configured to:
input the second training data into the text detection model;
acquire a second text score map and a second text mask for the second training data from the text detection model;
calculate a first text detection loss by comparing the acquired second text score map with the text detection GT of the second training data; and
calculate one or more of a text enhancement loss of the second training data and a second text detection loss by comparing the second text mask with the text detection GT of the second training data.

5. The apparatus for training the text detection model of claim 4, wherein the second training module is further configured to calculate the text enhancement loss of the second training data by using a false positive loss when comparing the second text mask with a blank region of the text detection GT of the second training data.

6. The apparatus for training the text detection model of claim 4, wherein the second training module is further configured to:
input the second text mask into the text detection model;
acquire a third text score map for the second text mask from the text detection model; and
calculate the second text detection loss by comparing the acquired third text score map with the text detection GT of the second training data.

7. The apparatus for training the text detection model of claim 4, wherein the second training module is further configured to calculate the loss of the second training by using the first text detection loss, the text enhancement loss, and the second text detection loss.

8. The apparatus for training the text detection model of claim 7, wherein the second training module is further configured to calculate the loss of the second training using the following equation:
L₂=λ₁L_{D}+(1−λ₁)(λ₂L_{D′}+(1−λ₂)L_{FP})
where L₂ is a loss function of the second training, L_{D} is the first text detection loss, L_{D′} is the second text detection loss, L_{FP} is the text enhancement loss of the second training data, and λ₁ and λ₂ are weights.

9. A method for training a text detection model, which is performed by a computing device comprising one or more processors and a memory storing one or more programs executed by the one or more processors, the method comprising:
a first training step of training the text detection model which receives a document image and outputs a text score map and a text mask for the document image by using first training data including text detection ground truth (GT) and text enhancement GT; and
a second training step of training the text detection model by using second training data including only the text detection GT.

10. The method of claim 9, wherein the first training step comprises:
inputting the first training data into the text detection model;
acquiring a first text score map and a first text mask for the first training data from the text detection model; and
calculating a loss of the first training step by comparing the acquired first text score map and first text mask with the text detection GT and the text enhancement GT of the first training data.

11. The method of claim 10, wherein the calculating of the loss of the first training step comprises calculating the loss of the first training step using the following equation:
L₁=λL_{D}+(1−λ)L_{E}
where L₁ is a loss function of the first training step, L_{D} is a text detection loss between the first text score map and the text detection GT of the first training data, L_{E} is a text enhancement loss between the first text mask and the text enhancement GT of the first training data, and λ is a weight.

12. The method of claim 9, wherein the second training step comprises:
inputting the second training data into the text detection model;
acquiring a second text score map and a second text mask for the second training data from the text detection model;
calculating a first text detection loss by comparing the acquired second text score map with the text detection GT of the second training data; and
calculating one or more of a text enhancement loss of the second training data and a second text detection loss by comparing the second text mask with the text detection GT of the second training data.

13. The method of claim 12, wherein the calculating of the one or more of the text enhancement loss of the second training data and the second text detection loss comprises calculating the text enhancement loss of the second training data by using a false positive loss when comparing the second text mask with a blank region of the text detection GT of the second training data.

14. The method of claim 12, wherein the calculating of the one or more of the text enhancement loss of the second training data and the second text detection loss comprises:
inputting the second text mask into the text detection model;
acquiring a third text score map for the second text mask from the text detection model; and
calculating the second text detection loss by comparing the acquired third text score map with the text detection GT of the second training data.

15. The method of claim 12, wherein the second training step further comprises calculating the loss of the second training step by using the first text detection loss, the text enhancement loss, and the second text detection loss.

16. The method of claim 15, wherein calculating of the loss of the second training step comprises calculating the loss of the second training step using the following equation:
L₂=λ₁L_{D}+(1−λ₁)(λ₂L_{D′}+(1−λ₂)L_{FP})
where, L₂ is a loss function of the second training step, L_{D} is the first text detection loss, L_{D′} is the second text detection loss, Li is the text enhancement loss of the second training data, and λ₁ and λ₂ are weights.
